(19) United States
(12) Patent Application Publication
(10) Pub. No.: US 2006/0129995 A1
(43) Pub. Date: Jun. 15, 2006

(54) Apparatus and method for observing runtime behavior of an application program

(76) Inventors: Benjamin L.G.J.P. DeBoe, Kontich (BE); Maarten E. Rits, Nice (FR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/999,315

(22) Filed: Nov. 30, 2004

(51) Int. Cl. G06F 9/44; G06F 9/45

(52) U.S. Cl. 717/127; 717/148

(57) ABSTRACT

A method and apparatus for observing runtime behavior of an application program. In one embodiment, the runtime behavior of the input program is observed according to at least one program target. Following execution of the input program, a report is generated to identify access to underlying layers of the input program directed to the at least one program target. In one embodiment, aspect oriented programming enables observation of the behavior of a running program. This enables the checking of each method invocation in the input program against a program target. This runtime information is extracted and provided as a report, which may be used to redesign an existing application for improving security or manageability. Other embodiments are described and claims.

### FIELD OF THE INVENTION

One or more embodiments of the invention relate generally to the field of multi-layered application program. More particularly, one embodiment relates to a method and apparatus for observing runtime behavior of an application program.

### BACKGROUND OF THE INVENTION

Advanced application programs may be formed by using multiple application layers. To achieve desired application program functionality, each application layer is assigned a specific responsibility. Some common examples of application layers of a multi-layer application include a database layer, a network interaction layer, an application layer, a user interface layer and the like.

Currently, secure software engineering research exists for describing and enforcing fine-grained access control policies in distributed as well as multi-layered environments. Such research enables the design of multi-layer applications, such as, for example, a three-layer application including a workflow layer, an application layer and a database layer. For each layer, specification of access control is required, such that the three different access control policies can map together to ensure a secure application.

As indicated above, to achieve application program functionality, the layers are generally required to interact with one another. Most interaction adheres to one pattern: methods of the upper layer petition services of the lower layer with returned information from the lower layer flowing upwards to the upper layers. As described herein, the issuance of a call, such as, for example, within a method or other programming language terminology to specify a block of code, such as, for example, a method, a function, a procedure or other like terminology, including a statement or call directed to some lower layer resource, is described herein as a “downcall.” Generally, determining information on which downcalls invoke critical methods or procedures, is performed by manually reading through the multi-layered application program code.

### BRIEF DESCRIPTION OF THE DRAWINGS

The various embodiments of the present invention are illustrated by way of example, and not by way of limitation, in the figures of the accompanying drawings and in which:

FIG. 1 is a block diagram illustrating a computer system for observing runtime behavior of an application program, in accordance with one embodiment.

FIG. 2 is a block diagram further illustrating a downcall sniffer module of FIG. 1, in accordance with one embodiment.

FIG. 3 is a block diagram illustrating downcall detection of calls issued by an executing input program directed to a program target within a lower application layer, in accordance with one embodiment.

FIG. 4 is a block diagram illustrating the operation of program modules to enable runtime observation of an input application program, in accordance with one embodiment.

FIG. 5 is a block diagram illustrating configuration manager modules for determining at least a user-specified program target with which to observe runtime program behavior, in accordance with one embodiment.

FIG. 6 illustrates class diagrams used to implement a configuration manager, in accordance with one embodiment.

FIG. 7 illustrates class diagrams to provide a program target with which to observe runtime behavior of an input program, in accordance with one embodiment.

FIG. 8 illustrates class diagrams for executing the input program to observe the runtime behavior thereof, in accordance with one embodiment.

FIG. 9 illustrates class diagrams for implementing report module to report detected downcalls directed to a program target, in accordance with one embodiment.

FIG. 10 illustrates class diagrams illustrating an output type for providing the report of detected downcalls within an input program, in accordance with one embodiment.

### DETAILED DESCRIPTION

In the following description, certain terminology is used to describe features of the invention. For example, the term “logic” is representative of hardware and/or software configured to perform one or more functions. For instance, examples of “hardware” include, but are not limited or restricted to, an integrated circuit, a finite state machine or even combinatorial logical. The integrated circuit may take the form of a processor such as a microprocessor, application specific integrated circuit, a digital signal processor, a micro-controller, or the like.

An example of “software” includes executable code in the form of an application, an applet, a routine or even a series of instructions. The software may be stored in any type of computer or machine readable medium such as a programmable electronic circuit, a semiconductor memory device inclusive of volatile memory (e.g., random access memory, etc.) and/or non-volatile memory (e.g., any type of read-only memory “ROM,” flash memory), a floppy diskette, an optical disk (e.g., compact disk or digital video disk “DVD”), a hard drive disk, tape, or the like.

System

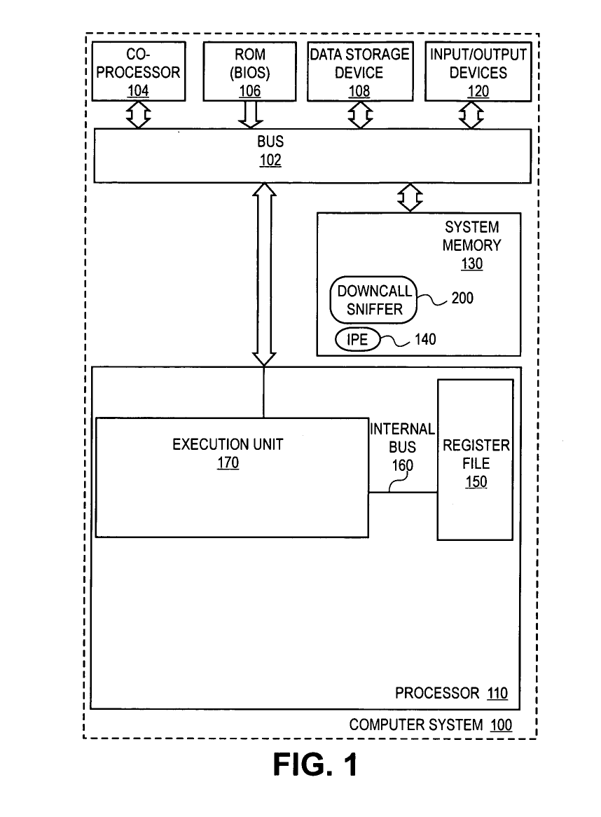

FIG. 1 shows a computer system 100 upon which one embodiment of observing runtime behavior of an application program can be implemented. Computer system 100 comprises a bus 102 for communicating information, and processor 110 coupled to bus 102 for processing information. Representatively, computer system 100 includes data storage device 108 and input/output (I/O) devices 120 coupled to bus 102. The computer system 100 also includes a system memory 130 coupled to bus 102 for storing information and instructions for processor 110, as well as optional co-processor 140. Processor 110 includes an execution unit 170 coupled to register file 150 via internal bus 160.

The system memory 130 may include high speed, temporary memory that is used by execution unit 170 to store frequently and/or recently used information for processor 110. As described herein, system memory 130 includes but is not limited to solid state memories, random access memory (RAM), non-volatile RAM (NVRAM), static RAM (SRAM), dynamic RAM (DRAM), synchronous DRAM (SDRAM), double rate (DDR) SDRAM, Rambus DRAM (RDRAM) or any device capable of supporting high speed buffering of data. In one embodiment, data storage device 108 includes one or more hard disks, floppy disks, ZIP disks, magnetic random access memory (MRAM) devices, and other system readable media that store instructions and/or data. Data storage device 108 may store program modules such as routines, programs, objects, images, data structures, program data, and other program modules that perform particular tasks or implement particular abstract data types that facilitate system use.

In one embodiment, execution unit 170 operates on image/video data according to the instructions received by processor 110. Execution unit 170 also operates on packed, floating-point and scalar data according to instructions implemented in general-purpose processors. In some embodiments, processor 110 may be an Intel 32-bit (IA-32) architecture. In another embodiment, the processor may have an Advanced Micro Devices 64-bit (AMD-64) architecture, an Intel EM64T architecture or an Intel IA-64 architecture that executes IA-32 code. The foregoing implies that the processor may use an IA-32 instruction set or an AMD-64 instruction set, respectively. In another embodiment, the processor 110 may be any processor that executes machine code generated from a Java compiler.

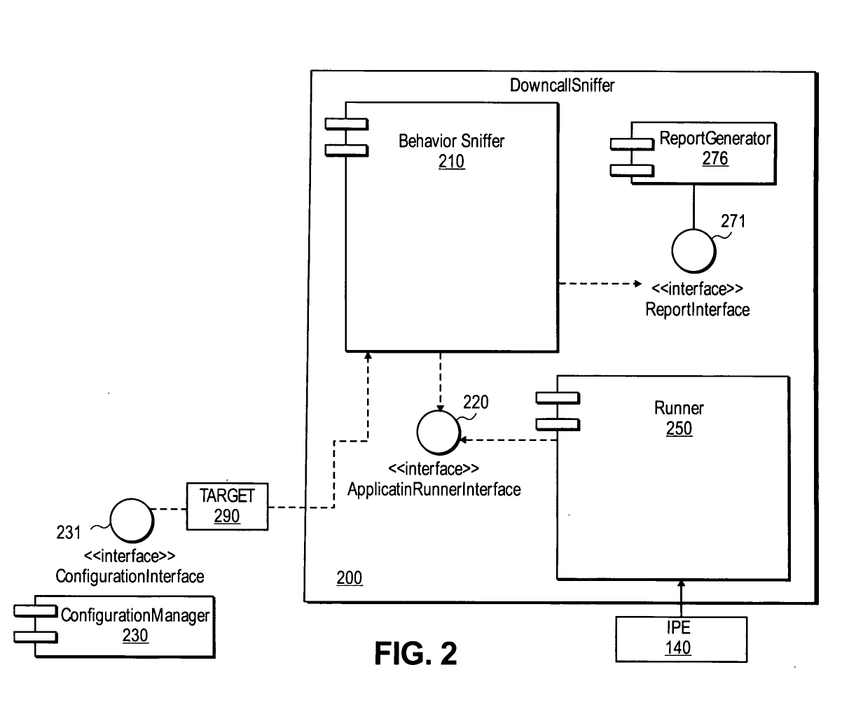

FIG. 2 is a block diagram further illustrating downcall sniffer module 200 of FIG. 1, in accordance with one embodiment. Representatively, downcall sniffer 200 includes behavior sniffer module 210. In one embodiment, behavior sniffer module 210 launches an input program executable (IPE) 140 using runner module 250 via application runner interface 220. Once IPE 140 begins executing, behavior sniffer module 210 observes the application to spot downcalls issued by the executing IPE to, for example, a lower application program layer, including program target 290.

In one embodiment, configuration manager 230 abstracts configuration settings for IPE 140. Such abstractions may include at least one program target 290, an input program path, a report format and other like information required to enable observation of an input program runtime behavior. In one embodiment, application runner interface 220 utilizes configuration interface 231 to determine where the input program or application is located. In one embodiment, this interface obstructs the processes needed to initialize and launch the desired type of program.

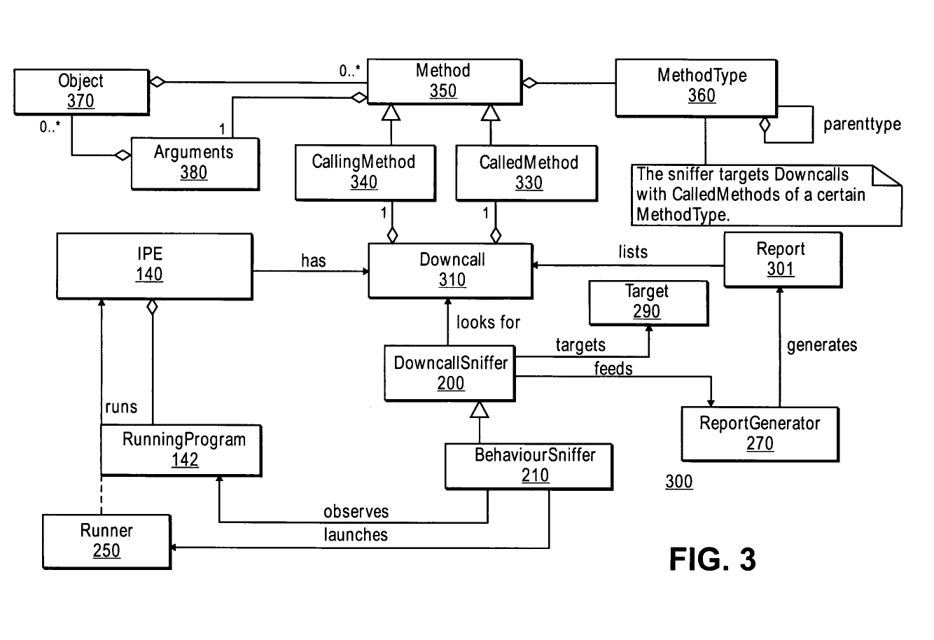

FIG. 3 is a block diagram 300 illustrating detection of downcalls issued by IPE 140 during runtime (running program 142 ), which are directed to an application target within an underlying layer of an input program, in accordance with one embodiment. Representatively, sniffer module 200, using behavior sniffer 210, observes running program 142, which is launched by runner 250. Behavior sniffer 210 observes running program 142 to determine whether the running program has issued a downcall 310, which matches at least one program target 290. When a matching downcall is detected, the matching downcall is registered with report generator module 270, which is responsible for generating report 301, which lists all detected downcalls directed to program target 290.

Representatively, the downcall sniffer 200 extracts a report on all downcalls issued by a procedure function, method or other like program construct, referred to herein as “calling methods” in the input application, which issue a call or invoke a method, procedure or the like block of program code offered by an underlying layer and specifically, the target 290. The target, or method looked for (“called methods”) should not be hard coded, such that users should be able to check which methods to look for at launch time. Accordingly, in one embodiment, for each detected downcall 310, report 301 lists the signature of the calling method, the signature of the called method and the arguments passed to the calling method. In one embodiment, this output is provided as an XML format, as shown in Table 1.

TABLE 1
<?xml version = “1.0” encoding = “ISO-8859-1”?>
<!DOCTYPE sniffingreport SYSTEM
“. ./downcallsniffer/report/report.dtd”>
<sniffingreport date_generated = “5 Aug 2004 12:06:59 GMT”>

<target>

<multipletarget boolean = “OR”>

<singletarget type = “methodname” pattern =
“methodA”/>

</multipletarget>

</target>
<downcall>

<targetobject>

<class fqname = “test.nuts.Hello”/>

<targetmethod fqname = “test.nuts.Hello.methodA” scope =
“package”>

<argument rank = “0”>

<class fqname = “java.lang.String”/>

</argument>

</targetmethod>
<stracktracelement rank = “0” filename = “Hello.java”

linenumber = “−1” methodname = “methodA”
“isnativemethod =

“FALSE”>

<class fqname = “test.nuts.Hello”/>

<stacktraceelement rank = “1” filename = “Hello.java”

linenumber = “13” methodname = “main
“isnativemethod =

“FALSE”>

<class fqname = “test.nuts.Hello”/>

</stacktraceelement>

</downcall>

</sniffingreport>

Referring again to FIG. 2, as described herein, method 350 is the domain specific concept corresponding to a method or function in the program code. A method 350 has an object 370 in which it is registered and an argument list. Object 370 symbolizes an object or class, which would have a certain amount of methods listed in it. An object has a class as its major property. Arguments 380 encapsulate the argument list of a given method. Method type 360 describes a method type, which is used by downcall sniffer 200 to extract information on calling methods, calling a method of a certain type (i.e., a database call).

As described above, calling method 340 is a method which calls the target method, so one level down the stack trace viewed from the calling method point of view. Called method 330 is a method calling the body of another method, the calling method, and downcall 310 is a call to a method from within the body of another method and lists the calling method and the called method as its properties. The object from which the call originates is the object of the calling method. In one embodiment, this information, along with a stack trace (defined herein as a succession of method calls beginning at an upper program layer and terminating at the called method, or target) are provided in report 301.

In one embodiment, the downcall sniffer module 200 is a modular tool, which examines a given application using aspect-oriented programming to observe the behavior of a running input program 142. Accordingly, in one embodiment, using aspect-oriented programming (AOP), at least one aspect is created to detect targeted downcalls 310. Once the at least one aspect is provided, advice is added to the targeted methods to export detected downcalls to a report 310.

Accordingly, in one embodiment, behavior sniffing aspects are first weaved into the existing code, then the application is launched to test every course of action within the input program. Finally, report 301 is generated to automatically provide detected downcalls 310. In one embodiment, a point cut is added to each method within the input program. Accordingly, for each method invocation issued by a method within the input program, advice is added to the point cut to compare the method invocation against the program target 290, such that when a downcall 310 is detected, the advice exports the detected downcall 310 to a report output file 301.

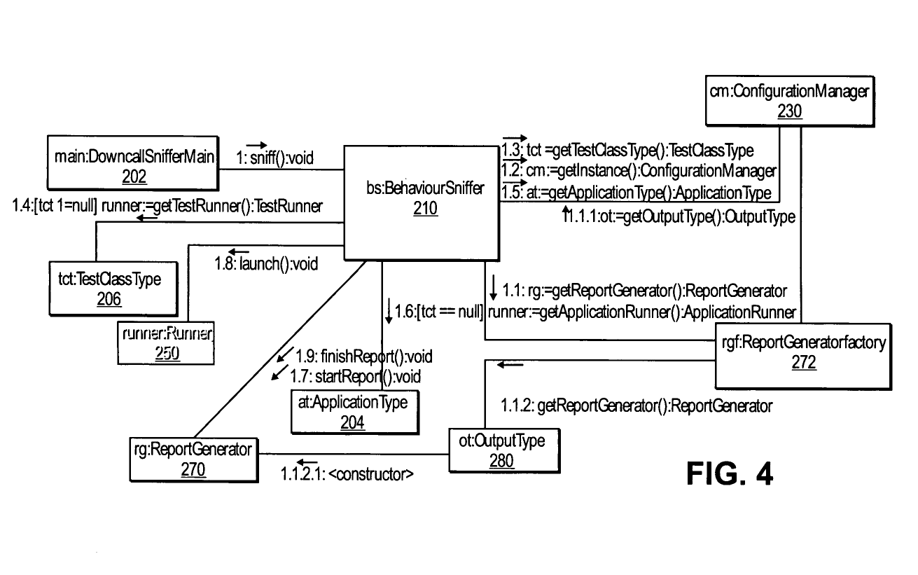

FIG. 4 is a collaboration diagram pointing out the behavior of behavior sniffer 210, in accordance with one embodiment. Once invoked by downcall sniffer main 202, behavior sniffer 210 detects all downcalls issued by an input program during runtime, which match a certain target within an input application program. In operation, a user registers the path of the input application in a sniffer configuration file (See, Table 2). In addition, the user registers a target in the sniffer configuration file and launches the sniffer tool using downcall sniffer main 202. In response, behavior sniffer 210 checks whether the input is valid. If the input is valid, the system executes the input application using runner 250 and observes the behavior of the application.

In one embodiment, sniffer 210 registers all downcalls directed to a certain program target in the input application. Once detected, report generator factory 272 generates a report, including all downcalls, based on an output type 280. Accordingly, downcall sniffer module 200 may be comprised of three components, in accordance with one embodiment. Such components may include behavior sniffer module 210, which performs the actual sniffing tasks, a report generating component 272 for providing a listing of detected downcalls and a runner component 250 for handling the running of the input program.

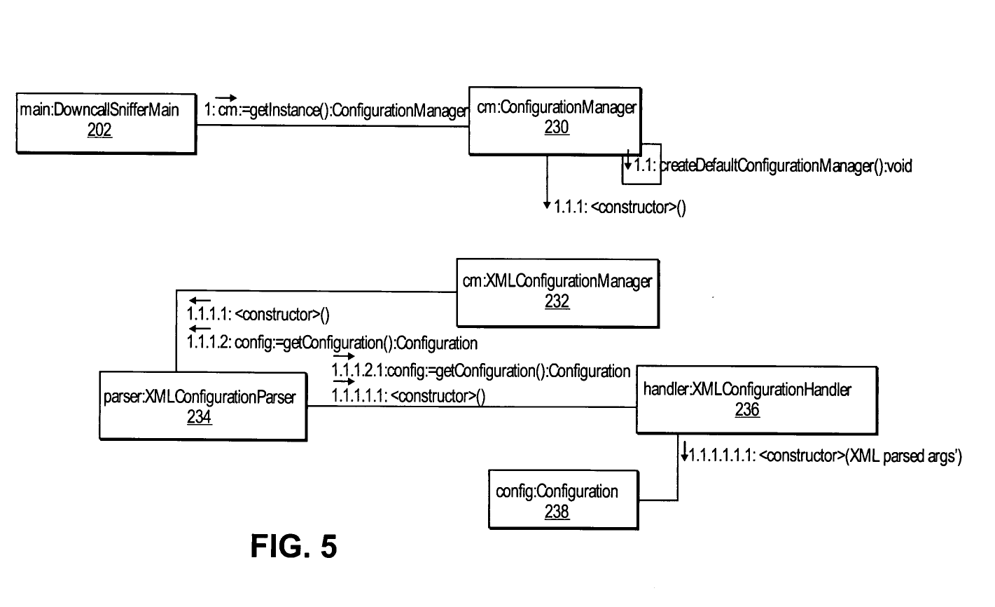

FIG. 5 is a block diagram illustrating diagrams describing the operation of configuration manager 230. Representatively, the configuration manager 230 determines a report format and at least one program target, as well as locations of any access files, such as the input program.

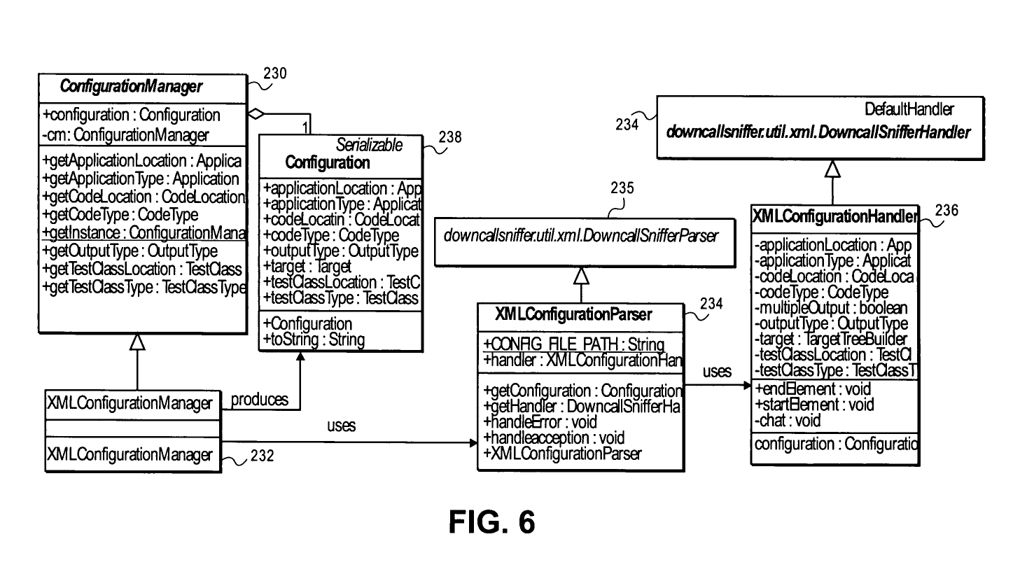

FIG. 6 illustrate class diagrams for implementing configuration manager 230. Representatively, the configuration manager utilizes XML configuration manager 232 to produce configuration 238 according to XML configuration parser 234 and XML configuration handler 236. Representatively, configuration 238 may include an application location, an application location type, a code location, a code location type, an output type and a target. Using such information, behavior sniffer 210 is able to execute the input application program to detect runtime downcalls directed to the program target.

Configuration interface 231 (See, FIG. 2) is a unified way for other components of the system to get the type, location or other properties of the application to be examined. Featured services of configuration interface include:

(1) gettarget. This method returns a target object describing the called method for which the downcalls should be extracted;

(2) getoutput type. This method returns an output type object encapsulating the type of output, which is expected.

(3) getapplication type. This method returns an application type object encapsulating the type of application to be examined;

(4) getapplication location. This method returns an application location object encapsulating the path to the executable application code to run.

In operation configuration manager 230 expects a configuration file to be present in the default path for example, as shown in Table 2. Representatively, configuration manager 231 abstracts the fetching of configuration settings.

TABLE 2

<?xml version = “1.0” encoding = “UTF-8”?>
<!DOCTYPE configuration SYSTEM “config.dtd”>
< configuration>

<target>

<mulltipletarget boolean = “OR”>

<singletarget type = “class” pattern =
“ClassY”><singletarget>
<singletarget type = “class” pattern =
“ClassX”><singletarget>
<mulltipletarget boolean = “NONE”>

<singletarget type = “methodname” pattern =
“methodA”/>

</multipletarget>

</target>
<output>

</multipleoutputtype>

<outputtype type = “XML”></outputtype>
<outputtype type = “console”></outputtype>

</multipleoutputtype>

</output>
<application path = “c:/projects/myApp.jar” type = “jar”
launchpoint =

“pack.ClassX”/>

<configuration>

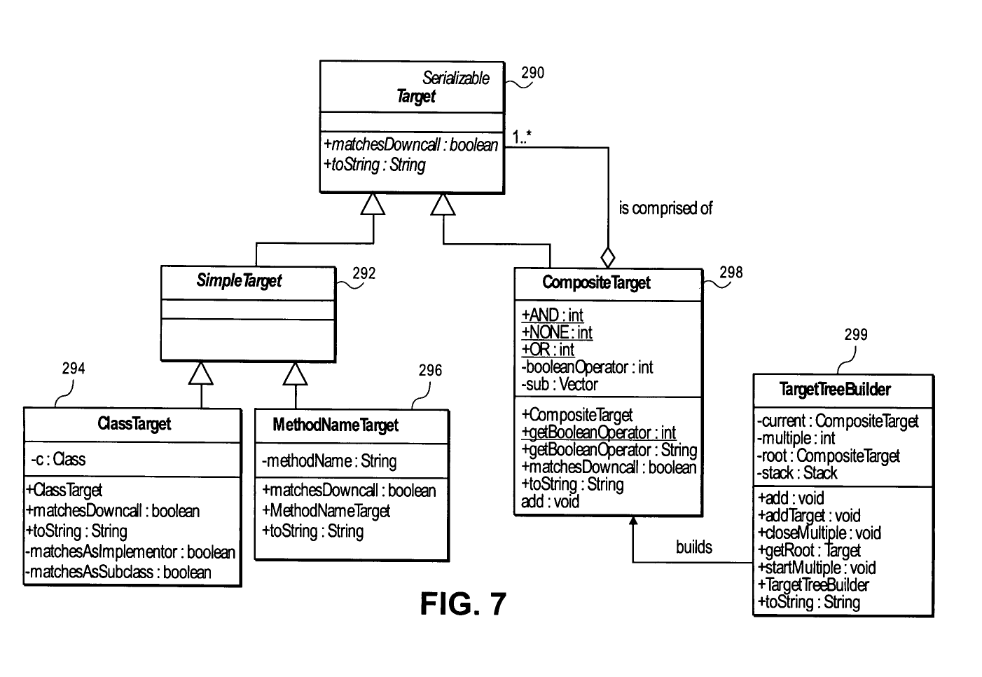

FIG. 7 illustrates class diagrams for implementing target 290. The various class target diagrams include simple target 292, which is based on class target 294, and method name target 296. Accordingly, as illustrated with reference to FIG. 7, a target 290 may be directed to a class of objects or limited to a specific method named target. Target 290 also includes composite target 298, which is built using target tree builder 299.

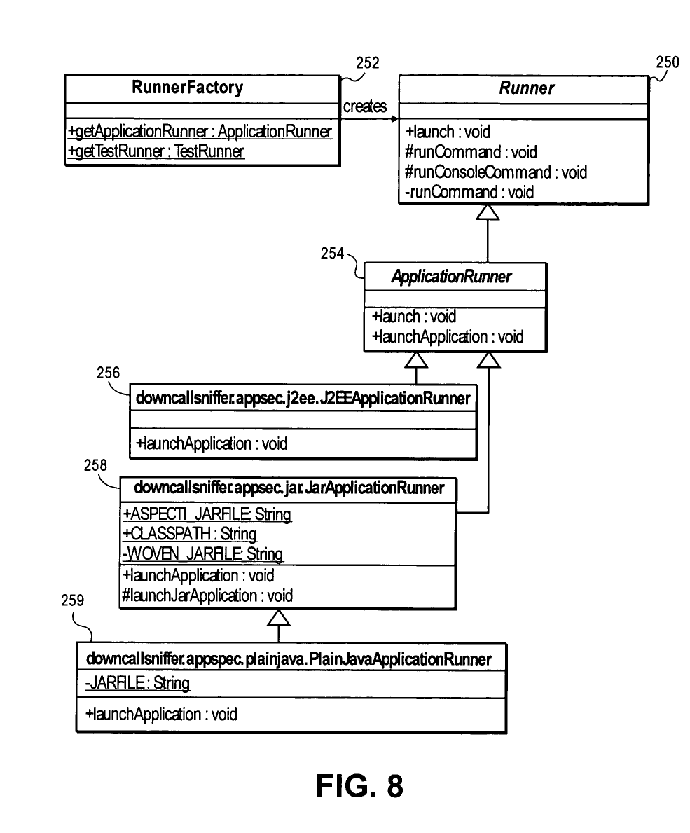

FIG. 8 illustrates class diagrams for implementing runner 250, as illustrated in FIGS. 2-4. Runner 250 is generated using runner factory 252, as well as application runner 254, which relies on various downcall sniffer files. Application runner 220 (FIG. 2) interface is used by behavior sniffer 210 to launch a program and keep the program running, looping through some kind of operational state in which the program works and its behavior can be observed. Featured services of application runner interface 220 include:
launch application used to activate the input program

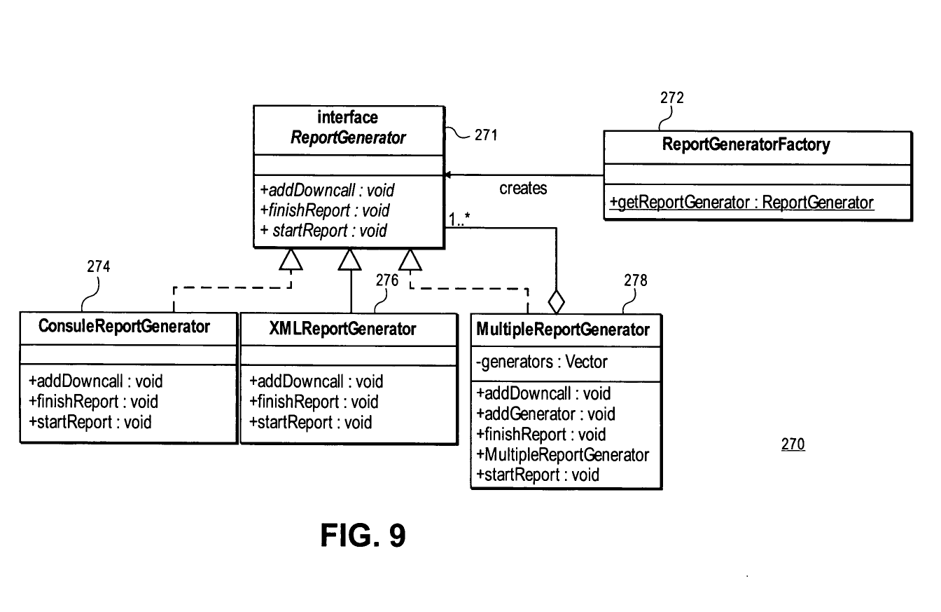

FIG. 9 illustrates class diagrams for providing report generator 270, and specifically, an interface 271 for report generator to provide the add downcall, finish report and start report functions. Representatively, report interface 271 offers services to different sniffer components for writing the information extracted regarding detected downcalls to a certain output. Accordingly, in one embodiment, report interface 271 provides a straightforward way to have a single access point for report generation. It provides loose coupling between the active sniffing components and the report generation. New output report generators should just implement this interface to be available. Featured services of the report interface include:
start report, finish report used to initialize and finalize the report
add downcall used to add a downcall item to the report

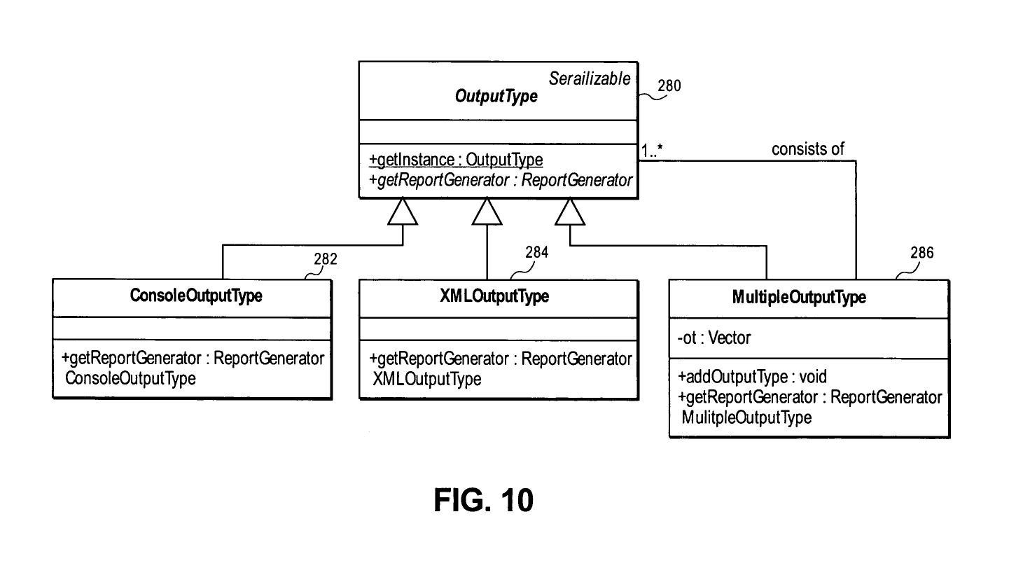

Finally, FIG. 10 illustrates class diagrams to provide the output type to generate the report for detected downcalls. Accordingly, the advantages of examining the behavior (opposed to examining the code) is the advanced form of tracing it provides. The method call matching the target is registered and a report with its corresponding stack-trace, which means that the application extracts the path from a first method through a succession of method calls to a calling method, which invokes the program target or called method. Accordingly, one embodiment provides a new way of automatically scanning a product for certain types of function calls without having to go through all program code by hand.

In one embodiment, the AOP approach also allows the detection of parameters passed during the execution of the application, which is generally information that cannot be extracted at runtime. In one embodiment, such information may be used for redesigning an existing application for improving, for example, security or manageability, which is greatly simplified if the application can be scanned, as described herein. For example, if one would like to enforce security policies to a certain type of method, the downcall report can point out where all those method calls occur (in which higher level calls invoked in). As a result, adding security functionality on the appropriate locations is only a matter of describing the target and adding the functionality, while avoiding an extensive study of the source code.

### Alternate Embodiments

Several aspects of one implementation of the downcall sniffer for providing a report including detected downcalls have been described. However, various implementations of the downcall sniffer provide numerous features including, complementing, supplementing, and/or replacing the features described above. Features can be implemented for downcall detection within a multi-layered application or for a distributed application in different embodiment implementations. In addition, the foregoing description, for purposes of explanation, used specific nomenclature to provide a thorough understanding of the embodiments of the invention. However, it will be apparent to one skilled in the art that the specific details are not required in order to practice the embodiments of the invention.

In addition, although an embodiment described herein is directed to a downcall detection, it will be appreciated by those skilled in the art that the embodiments of the present invention can be applied to other systems. In fact, systems for generating test data to invoke each method within an application fall within the embodiments of the present invention, as defined by the appended claims. The embodiments described above were chosen and described in order to best explain the principles of the embodiments of the invention and its practical applications. These embodiments were chosen to thereby enable others skilled in the art to best utilize the invention and various embodiments with various modifications as are suited to the particular use contemplated.

It is to be understood that even though numerous characteristics and advantages of various embodiments of the present invention have been set forth in the foregoing description, together with details of the structure and function of various embodiments of the invention, this disclosure is illustrative only. In some cases, certain subassemblies are only described in detail with one such embodiment. Nevertheless, it is recognized and intended that such subassemblies may be used in other embodiments of the invention. Changes may be made in detail, especially matters of structure and management of parts within the principles of the embodiments to the full extent indicated by the broad general meaning of the terms in which the appended claims are expressed.

Having disclosed exemplary embodiments and the best mode, modifications and variations may be made to the disclosed embodiments while remaining within the scope of the embodiments of the invention as defined by the following claims.

What is claimed is:

1. A method, comprising:
observing, during execution of an input program, the behavior of the input program according to at least one program target; and
generating a report to identify access to underlying layers of the input program directed to the at least one program target.

2. The method of claim 1, wherein observing the behavior further comprises:
detecting a method call directed to the program target within a calling method;
determining a stack trace for the detected method call; and
registering the detected method call and stack trace.

3. The method of claim 2, wherein determining the stack trace further comprises extracting a path from a method within an upper layer of the input program to the calling method to invoke the program target.

4. The method of claim 1, wherein the program target is one of a service, a method, a class and a resource.

5. The method of claim 1, wherein prior to observing, the method further comprises accessing a configuration file to determining the at least one program target and a report format.

6. The method of claim 1, wherein observing the behavior further comprises:
checking each method invocation issued by the input program against the at least one program target; and
identifying each issued method invocation directed to the program target.

7. The method of claim 6, wherein identifying each issued method invocation further comprises:
outputting, for each identified method invocation, a signature of a calling method that issued the identified method invocation, a signature of a called method by the method invocation and arguments passed to the called method.

8. The method of claim 1, wherein prior to observing the behavior, the method further comprises:
creating at least one aspect within the input program to identify each downcall issued during execution of the input program and direct to the program target; and
adding advice to the at least one aspect within the input program to export a path from a method within an upper layer of the input program to the calling method that invoked the program target.

9. The method of claim 8, wherein creating at least one aspect further comprises inserting a point cut within at least one method of the input program to check the method against the program target.

10. The method of claim 8, wherein creating at least one aspect further comprises inserting a point cut within each method of the input program to check each call issued by each method against the program target.

11. A method, comprising:
executing an input program;
identifying each downcall issued by the input program to at least one program target within an underlying layer of the input program; and
outputting, for each identified downcall, a signature of a calling module that issued the identified downcall, a signature of a called module by the identified module invocation and arguments passed to the called module.

12. The method of claim 11, wherein prior to executing the input program, the method further comprises:
creating at least one aspect within the input program to identify each downcall issued during execution of the input program and direct to the program target; and
adding advice to the at least one aspect within the input program to export a path from a method within an upper layer of the input program to the calling method that invoked the program target.

13. The method of claim 12, wherein creating at least one aspect further comprises inserting a point cut within at least one method of the input program to check the method against the program target.

14. The method of claim 12, wherein creating at least one aspect further comprises inserting a point cut within each method of the input program to check each call issued by each method against the program target.

15. The method of claim 11, wherein outputting further comprises generating a report to identify access to underlying layers of the input program directed to the at least one program target.

16. The method of claim 11, wherein a downcall comprises a call to a called method within a body of a calling method.

17. A machine accessible medium including instructions that when executed cause the machine to:
execute an input program;
identify each downcall issued by the input program to at least one program target within an underlying layer of the input program; and
output, for each identified downcall, a signature of a calling module that issued the identified downcall, a signature of a called module by the identified module invocation and arguments passed to the called module.

18. The machine accessible medium of claim 17, wherein prior to executing the input program, the machines is further to:
create at least one aspect within the input program to identify each downcall issued during execution of the input program and direct to the program target; and
add advice to the at least one aspect within the input program to export a path from a method within an upper layer of the input program to the calling method that invoked the program target.

19. The machine accessible medium of claim 18, wherein to create at least one aspect, the machine is further to:
insert a point cut within at least one method of the input program to check the method against the program target.

20. The machine accessible medium of claim 17, wherein to create the at least one aspect, the machine is further to:
insert a point cut within each method of the input program to check each call issued by each method against the program target.

21. The machine accessible medium of claim 17, wherein to output, the machine is further to:
generate a report to identify access to underlying layers of the input program directed to the at least one program target.

22. A machine accessible medium including instructions that when executed cause the machine to:
execute an input program;
observe the behavior of the input program according to at least one program target; and
generate a report to identify access to underlying layers of the input program directed to the at least one program target.

23. The machine accessible medium of claim 22, wherein to observe the behavior, the machine is further to:
detect a method call directed to the program target within a calling method;
determine a stack trace for the detected method call; and
register the detected method call and stack trace.

24. The machine accessible medium of claim 23, wherein to determine the stack trace, the machine is further to:
extract a path from a method within an upper layer of the input program to the calling method to invoke the program target.

25. The machine accessible medium of claim 22, wherein to observe the behavior, the machine is further to:
check each method invocation issued by the input program against the at least one program target; and
identify each issued method invocation directed to the program target.

26. The machine accessible medium of claim 25, wherein to identify each issued method invocation, the machine is further to:
output, for each identified method invocation, a signature of a calling method that issued the identified method invocation, a signature of a called method by the method invocation and arguments passed to the called method.

27. A system, comprising:
an execution module to execute an input program;
a downcall module to detect each downcall issued by the input program and directed to at one user supplied program target; and
a report module to output, for each identified downcall, a signature of a calling module that issued the identified downcall, a signature of a called module by the identified module invocation and arguments passed to the called module.

28. The system of claim 27, further comprising:
an execution module to execute the input program to invoke each method within the input program

29. The system of claim 27, further comprising:
an aspect module to create at least one aspect within the input program to identify each downcall issued during execution of the input program and direct to the program target.

30. The system of claim 29, wherein the aspect module is further to adding advice to the at least one aspect within the input program to export a path from a method within an upper layer of the input program to the calling method that invoked the program target.
